(19) United States
(12) Patent Application Publication
(10) Pub. No.: US 2019/0278243 A1
(43) Pub. Date: Sep. 12, 2019

(54) MOTOR CONTROL SYSTEM

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Kazuki HANAFUSA, Inagi Tokyo (JP)

(21) Appl. No.: 16/115,297

(22) Filed: Aug. 28, 2018

(30) Foreign Application Priority Data
Mar. 6, 2018 (JP) 2018-039403

(51) Int. Cl. G05B 19/042

(52) U.S. Cl. CPC G05B 19/042; G05B 2219/41112

(57) ABSTRACT

A motor control system includes a motor, a main controller configured to receive a first user program from a user device, and a motor controller configured to store the first user program transferred from the main controller such that the first user program is not readable from outside of the motor control system.

### CROSS-REFERENCE TO RELATED APPLICATION

This application is based upon and claims the benefit of priority from Japanese Patent Application No. 2018-039403, filed Mar. 6, 2018, the entire contents of which are incorporated herein by reference.

### FIELD

Embodiments described herein relate generally to a motor control system.

### BACKGROUND

Recent motor control systems are required to control not only motors but other peripheral devices such as a communication device. To meet such requirements, the motor control system has a multi-core processor provided with multiple co-processors (i.e., auxiliary processors) for handling multiple control operations.

The co-processor performs a predetermined control program stored in advance in an internal memory, for example, a read only memory (ROM). For this reason, a user of the motor control system or a manufacturer of another system using the motor control system cannot use any control programs except for the pre-loaded control programs on the motor control system.

### DESCRIPTION OF THE DRAWINGS

FIG. 1 is a view illustrating a motor control system according to a first embodiment.

FIG. 2 is a flowchart illustrating an operation of storing a motor control program according to the first embodiment.

FIG. 3 is a view illustrating contents of the motor control program according to the first embodiment.

FIG. 4 is a flowchart illustrating an operation of the motor control system according to the first embodiment.

FIG. 5 is a view illustrating a motor control system according to a second embodiment.

FIG. 6 is a flowchart illustrating an operation of storing a motor control program according to the second embodiment.

FIG. 7 is a view illustrating a motor control system according to a third embodiment.

FIG. 8 is a flowchart illustrating an operation of storing a communication control program according to the third embodiment.

FIG. 9 is a flowchart illustrating an operation of the motor control system according to the third embodiment.

### DETAILED DESCRIPTION

Embodiments provide a motor control system capable of enabling a user to implement a control processing except for a predetermined control processing.

According to one embodiment, a motor control system includes a motor, a main controller configured to receive a first user program from a user device, and a motor controller configured to store the first user program transferred from the main controller such that the first user program is not readable from outside of the motor control system.

Hereinafter, embodiments of the present disclosure will be described with reference to the drawings.

### First Embodiment

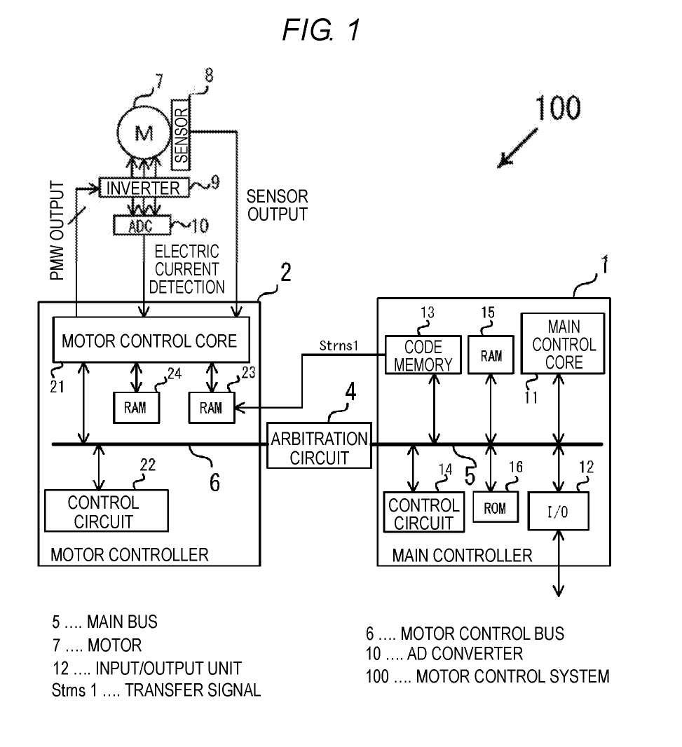

First, a motor control system according to a first embodiment will be described with reference to the drawings. FIG. 1 is a view illustrating the motor control system.

In an embodiment, a code memory, which enables a user to store a motor control program, is provided in a main controller, and the user's own motor control program stored in the code memory is transferred to a memory of a motor controller.

As illustrated in FIG. 1, a motor control system 100 includes a main controller 1, a motor controller 2, an arbitration circuit 4, a motor 7, a sensor 8, an inverter 9, and an analog-to-digital (AD) converter 10. The motor control system 100 is mounted in a customer appliance or an industrial apparatus, and for example, the motor control system 100 is applied to home electric appliances such as a refrigerator or an air conditioner, robotics such as a service robot or a nursing robot, factory automation (FA), and the like.

The main controller 1 integrally manages the motor control system 100. The main controller 1 includes a main bus 5, a main control core 11, an input/output unit 12, a code memory 13, a control circuit 14, a random access memory (RAM) 15, and a ROM 16.

The main bus 5 is connected to the arbitration circuit 4. The main control core 11, the input/output unit 12, the code memory 13, the control circuit 14, the RAM 15, and the ROM 16, which are provided in the main controller 1, are connected to each other through the main bus 5.

The main control core 11 integrally controls the motor control system 100 and the main controller 1. The main control core 11 is a processor or a processor core that performs a digital signal processing and plays the same role as a central processing unit (CPU), a micro processing unit (MPU), a micro controller, or the like.

Various types of information inside the motor control system 100 are output to the outside through the input/output unit 12, and various types of information outside the motor control system 100 is input to the main controller 1 through the input/output unit 12.

The code memory 13 is a nonvolatile memory that stores a motor control program (i.e., motor control algorithm). The code memory 13 stores a user's own motor control program or the like through the input/output unit 12 or directly stores the user's own motor control program at the time of factory shipment. The user includes a user who uses the motor control system or a manufacturer of another system using the motor control system. Based on an instruction of the main control core 11, the code memory 13 stores the motor control program stored in the ROM 16 or the RAM 15 of the main controller 1.

Based on the instruction of the main control core 11, the control circuit 14 performs, at a high speed, various types of control including direct memory access (DMA) transfer. Based on the instruction of the main control core 11, the ROM 16 and the RAM 15 input and store various types of information.

The motor controller 2 includes a motor control bus 6, a motor control core 21, a control circuit 22, a RAM 23, and a RAM 24. The motor controller 2 controls the motor 7. The motor control core 21 and the control circuit 22, which are provided in the motor controller 2, are connected to each other through the motor control bus 6. The motor control bus 6 is connected to the arbitration circuit 4. The RAM 23 and the RAM 24 are not connected to the motor control bus 6. For this reason, the information stored in the RAM 23 and the RAM 24 cannot be read out through the motor control bus 6.

The motor 7 is, for example, a three-phase motor. The sensor 8 is disposed around the motor 7 and detects information about a position of the motor, an operating status of the motor, surrounding environment, or the like. The inverter 9 inputs a three-phase PWM output signal and outputs a signal for controlling a rotation of the motor 7, based on the three-phase PWM output signal, to the motor 7. The motor 7 operates based on the signal output from the inverter 9.

The AD converter 10 is also called an analog-to-digital converter (ADC). The AD converter 10 detects an electric current (analog value) flowing through a coil of the motor 7 and detects the electric current by performing an analog-digital transform processing.

The motor control core 21 is a processor or a processor core that performs a digital signal processing and controls the motor 7. The motor control core 21 inputs sensor output information output from the sensor 8 and inputs electric current detection information output from the AD converter 10. For example, the motor control core 21 performs control such as rotor position detection, control of an ambient temperature of the motor 7, speed control, electric current control, phase conversion, coordinate conversion, opposite phase conversion, and three-phase pulse width modulation (PWM) output. The motor control core 21 outputs the three-phase PWM output to the inverter 9.

Based on the instruction of the motor control core 21, the control circuit 22 performs various types of control including another transfer processing performed by the motor control core 21.

The RAM 23 is an instruction memory that stores a program (i.e., algorithm) for performing driving control on the motor 7. For example, the RAM 23 receives the user's own motor control program stored in the code memory 13 as a transfer signal Strns1 and stores the program. For example, the motor control core 21 reads out the user's own motor control program stored in the RAM 23 and controls the motor 7 based on the user's own motor control program. Further, in some instances, the motor control core 21 controls the motor 7 based on a typical motor control program stored in advance in the ROM 16 or the RAM 15.

Here, since the RAM 23 is not connected to the motor control bus 6, the information stored in the RAM 23 cannot be read out, written, or erased by the main control core 11 or the user.

The RAM 24 is a data memory that stores information associated with multiple jobs to be performed by the motor controller 2. Since the RAM 24 is not connected to the motor control bus 6, the information stored in the RAM 24 cannot be read out, written, or erased by the main control core 11 or the user.

The arbitration circuit 4 is connected to the main bus 5 of the main controller 1 and the motor control bus 6 of the motor controller 2 and determines the order of priority of the multiple jobs to be performed on the main bus 5 and the motor control bus 6. For this reason, it is possible to achieve high speed and real time control in the motor control system 100.

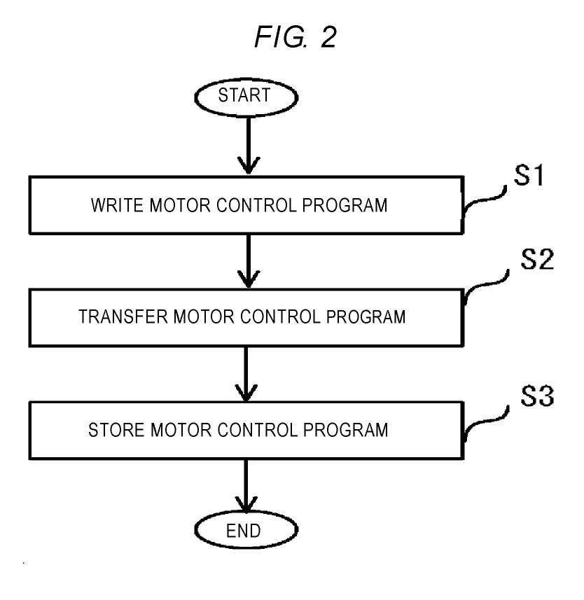

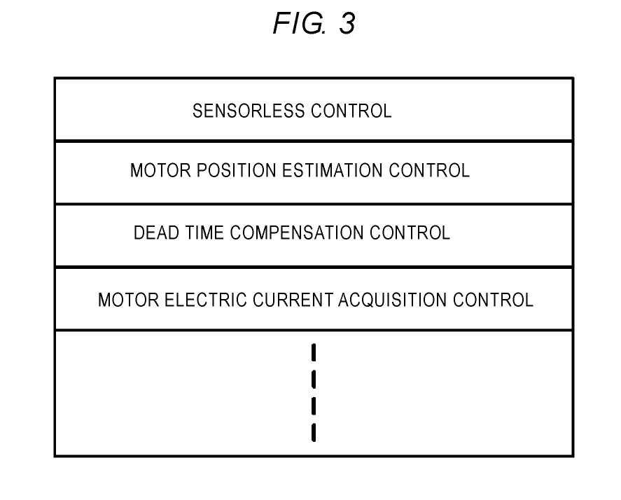

Next, the storage of the motor control program will be described with reference to FIGS. 2 and 3. FIG. 2 is a flowchart illustrating an operation of storing the motor control program in the motor controller 2. FIG. 3 is a list of operations performed by the motor control program.

As illustrated in FIG. 2, a user operates his or her user terminal to write the user's own motor control program into the code memory 13 of the main controller 1 through the input/output unit 12 (step S1). The user's own motor control program is written in the code memory 13 based on the instruction of the main control core 11.

Here, the user's own motor control program includes sensorless control, motor position estimation control, dead time compensation control, motor electric current acquisition control, and the like, as illustrated in FIG. 3. By using the user's own motor control program, it is possible to implement functions that are not provided by default configuration. As a result, in the motor control system 100, in addition to typical motor control, the user's own motor control may be implemented at any time by writing the user's own motor control program.

Next, the main control core 11 provides a transfer instruction to the control circuit 14. The control circuit 14 reads out and transfers, at a high speed (e.g., DMA transfer), the user's own motor control program stored in the code memory 13, and outputs the user's own motor control program, as the transfer signal Strns1, to the RAM 23 of the motor controller 2 (step S2).

Next, the RAM 23 stores the transferred user's own motor control program (step S3).

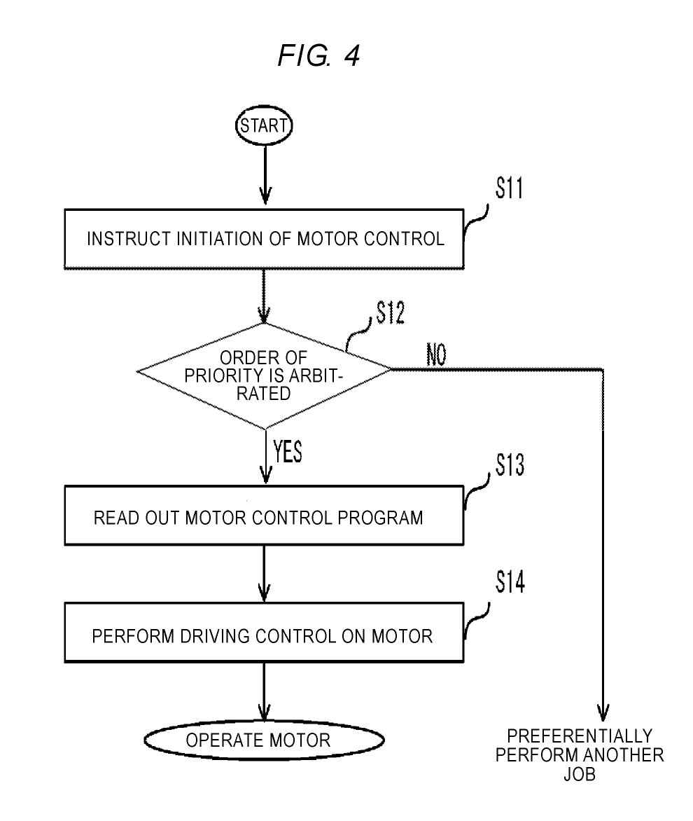

Next, an operation of the motor control system will be described with reference to FIG. 4. FIG. 4 is a flowchart illustrating the operation of the motor control system.

As illustrated in FIG. 4, the main control core 11 instructs the motor control core 21 to initiate the motor control on the motor 7 (step S11).

Next, the arbitration circuit 4 determines the order of priority of multiple jobs to be performed by the motor control system 100 (step S12). When the arbitration circuit 4 determines the priority of the motor control as a top priority (YES at step S12), the arbitration circuit 4 transfers the instruction of the initiation of the motor control to the motor control core 21 on the top priority basis. When the arbitration circuit 4 does not determine the priority of the motor control as the top priority (NO at step S12), another job is set as the top priority basis. In the motor control system 100 of an embodiment, the main controller 1 and the motor controller 2 each have an independent processor core, and as a result, the main controller 1 and the motor controller 2 may perform the control in parallel.

Next, the motor control core 21 reads out the user's own motor control program stored in the RAM 23 (step S13).

The motor control core 21 initiates the driving control on the motor 7 based on the user's own motor control program (step S14).

As described above, the motor control system 100 of an embodiment is provided with the main controller 1, the motor controller 2, the arbitration circuit 4, the motor 7, the sensor 8, the inverter 9, and the AD converter 10. The main controller 1 includes the main bus 5, the main control core 11, the input/output unit 12, the code memory 13, the control circuit 14, the RAM 15, and the ROM 16. The code memory 13 obtains the motor control program (i.e., motor control algorithm) from the user and stores the motor control program (i.e., motor control algorithm). The motor controller 2 includes the motor control bus 6, the motor control core 21, the control circuit 22, the RAM 23, and the RAM 24. The RAM 23 stores the motor control program (i.e., algorithm) transferred from the code memory 13. The RAM 23 is not connected to the motor control bus 6.

For this reason, the motor control system 100 may implement the user's own motor driving control. In addition, since the motor control program (i.e., motor control algorithm) stored in the RAM 23 cannot be read out from the main controller 1 and the outside, it is possible to improve security.

The RAM 23 (i.e., instruction RAM) and the RAM 24 (i.e., data RAM) of the motor controller 2 may be configured as a single RAM. While the driving control is performed on the motor 7 (i.e., a single motor) using the motor controller 2 in the motor control system 100 of the aforementioned embodiments, the driving control may be performed on multiple motors using the motor controller 2.

### Second Embodiment

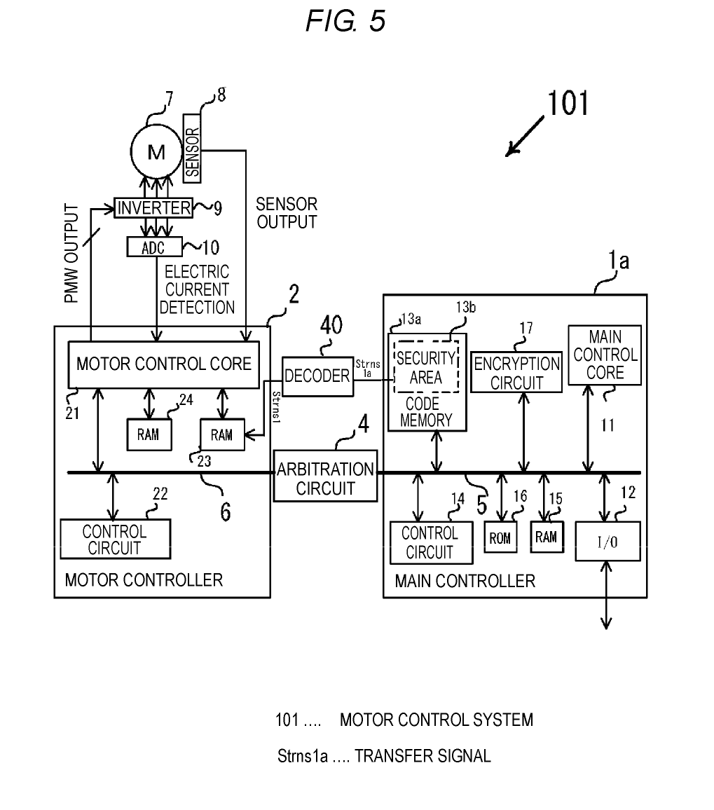

Next, a motor control system according to a second embodiment will be described with reference to the drawings. FIG. 5 is a view illustrating the motor control system.

In the present embodiment, security is improved by encrypting the user's own motor control program.

Hereinafter, parts identical to those in the first embodiment are designated by the same reference numerals, descriptions thereof will be omitted, and only the differences will be described.

As illustrated in FIG. 5, a motor control system 101 includes a main controller 1a, a motor controller 2, an arbitration circuit 4, a motor 7, a sensor 8, an inverter 9, an AD converter 10, and a decoder 40.

The main controller 1a integrally controls the motor control system 101. The main controller 1a includes a main bus 5, a main control core 11, an input/output unit 12, a code memory 13a, a control circuit 14, a RAM 15, a ROM 16, and an encryption circuit 17.

The main bus 5 is connected to the arbitration circuit 4. The main control core 11, the input/output unit 12, the code memory 13, the control circuit 14, the RAM 15, the ROM 16, and the encryption circuit 17, which are provided in the main controller 1a, are connected to each other through the main bus 5.

The encryption circuit 17 encrypts a user's own motor control program. As an encryption method, an advanced encryption standard (AES) method, a data encryption standard (DES) method, an RSA method, an encryption method uniquely developed by the user, or the like is used. Further, the RSA is a code name that stands for initials of R. L. Rivest, A. Shamir, and L. Adleman.

The code memory 13a includes a security area 13b. The security area 13b stores the user's own motor control program encrypted by the encryption circuit 17.

The decoder 40 is provided between the main controller la and the motor controller 2. The decoder 40 receives a transfer signal Strns1a which is the encrypted user's own motor control program transferred from the security area 13b, and the decoder 40 performs decoding (i.e., decryption). The decoder 40 transfers a transfer signal Strns1, which is the decoded (i.e., decrypted) user's own motor control program, to the RAM 23 of the motor controller 2.

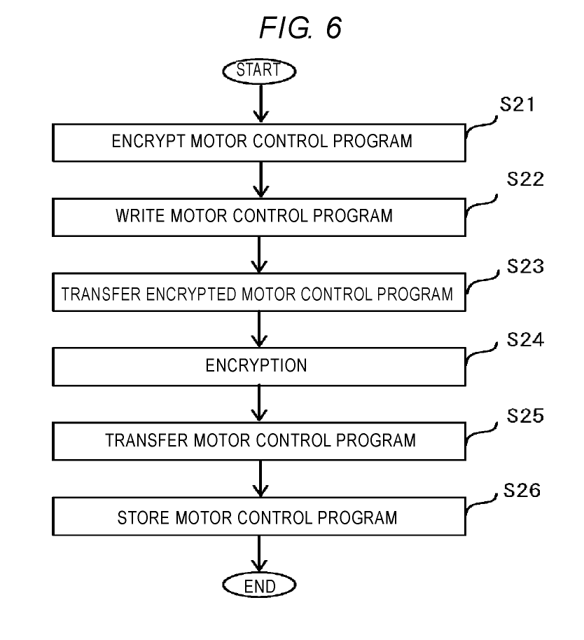

Next, the storage of the motor control program will be described with reference to FIG. 6. FIG. 6 is a flowchart illustrating an operation of storing the motor control program.

As illustrated in FIG. 6, the user operates his or her terminal to transmit the user's motor control program (i.e., motor control algorithm) information to the main controller 1a. Based on the instruction of the main control core 11 of the main controller 1a, the encryption circuit 17 of the main controller 1a encrypts the user's own motor control program (step S21).

Next, based on the instruction of the main control core 11, the control circuit 14 transfers the encrypted user's own motor control program at a high speed, for example, performs the DMA transfer, and stores the encrypted user's own motor control program in the security area 13b of the code memory 13a (step S22).

Next, based on the instruction of the main control core 11, the control circuit 14 transfers the encrypted user's own motor control program, as the transfer signal Strns1a, which is stored in the security area 13b, to the decoder 40 (step S23).

The decoder 40 decodes (i.e., decrypts) the encrypted user's own motor control program and transfers the decoded user's own motor control program, as the transfer signal Strns1, to the RAM 23 of the motor controller 2 (step S25).

Next, the RAM 23 stores the transferred user's own motor control program (step S26).

As described above, the motor control system 101 of an embodiment is provided with the main controller 1a, the motor controller 2, the arbitration circuit 4, the motor 7, the sensor 8, the inverter 9, the AD converter 10, and the decoder 40. The main controller 1a includes the main bus 5, the main control core 11, the input/output unit 12, the code memory 13a, the control circuit 14, the RAM 15, the ROM 16, and the encryption circuit 17. The encryption circuit 17 encrypts the user's own motor control program. The security area 13b of the code memory 13a stores the encrypted user's own motor control program. The decoder 40 decodes the encrypted user's own motor control program and transfers the decoded user's own motor control program to the RAM 23. The RAM 23 stores the user's own motor control program.

For this reason, it is possible to further improve security in comparison with the first embodiment while having the same effect as the first embodiment.

### Third Embodiment

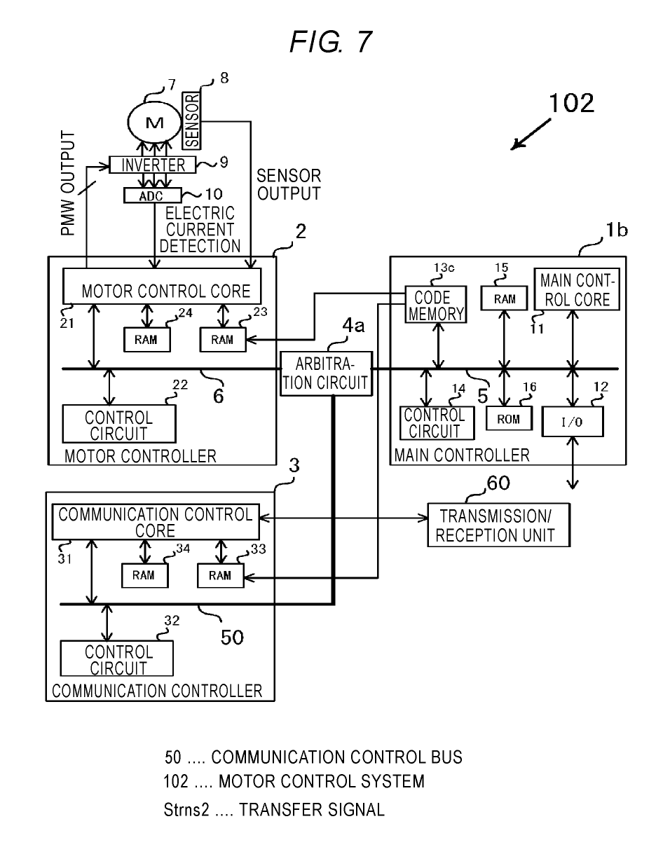

Next, a motor control system according to a third embodiment will be described with reference to the drawings. FIG. 7 is a view illustrating the motor control system.

In an embodiment, a code memory, which enables a user to store a communication control program and a motor control program, is provided in a main controller, the communication control program stored in the code memory is transferred to a memory of a communication controller, the motor control program stored in the code memory is transferred to a memory of a motor controller, and the order of priority of jobs is determined by an arbitration circuit.

Hereinafter, parts identical to those in the first embodiment are designated by the same reference numerals, descriptions thereof will be omitted, and only the differences will be described.

As illustrated in FIG. 7, a motor control system 102 includes a main controller 1b, a motor controller 2, a communication controller 3, an arbitration circuit 4a, a motor 7, a sensor 8, an inverter 9, an AD converter 10, and a transmission/reception unit 60.

The main controller 1b integrally controls the motor control system 102. The main controller 1b includes a main bus 5, a main control core 11, an input/output unit 12, a code memory 13c, a control circuit 14, a RAM 15, and a ROM 16.

The main bus 5 is connected to the arbitration circuit 4a. The main control core 11, the input/output unit 12, the code memory 13c, the control circuit 14, the RAM 15, and the ROM 16, which are provided in the main controller 1b, are connected to each other through the main bus 5. The main control core 11 integrally controls the motor control system 102 and the main controller 1b.

The code memory 13c is a nonvolatile memory that stores the motor control program (i.e., motor control algorithm) and the communication control program (i.e., communication control algorithm). The code memory 13c stores a user's own motor control program or communication control program owned by the user through the input/output unit 12.

The communication controller 3 includes a communication control bus 50, a communication control core 31, a control circuit 32, a RAM 33, and a RAM 34. The communication controller 3 controls the transmission/reception unit 60. The transmission/reception unit 60 includes, for example, a base band processing unit, a transmission unit, a reception unit, and an antenna which are not illustrated. The base band processing unit performs a digital signal processing.

The communication control core 31 and the control circuit 32, which are provided in the communication controller 3, are connected to each other through the communication control bus 50. The control circuit 32 performs jobs other than the jobs performed by the communication control core 31 (i.e., communication control). The communication control bus 50 is connected to the arbitration circuit 4a. The RAM 33 and the RAM 34 are not connected to the communication control bus 50.

The RAM 33 stores the user's own communication control program (i.e., communication control algorithm) transferred from the code memory 13c. Since the RAM 33 is not connected to the communication control bus 50, the information stored in the RAM 33 cannot be read out, written, or erased by the main control core 11 or the user.

The RAM 34 is a data memory that stores information associated with multiple jobs to be performed by the communication controller 3. Since the RAM 34 is not connected to the communication control bus 50, the information stored in the RAM 34 cannot be read out, written, or erased by the main control core 11 or the user.

The arbitration circuit 4a is connected to the main bus 5 of the main controller 1b, the motor control bus 6 of the motor controller 2, and the communication control bus 50 of the communication controller 3, and determines the order of priority of multiple jobs to be performed on the main bus 5, the motor control bus 6, and the communication control bus 50. The job, which is determined as the top priority, is performed preferentially compared to other jobs, and as a result, it is possible to implement the control of the motor control system 102 at a high speed and in real time.

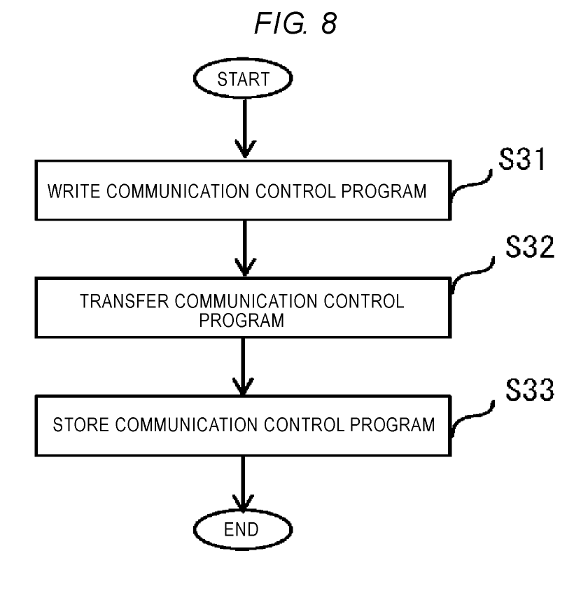

Next, the storage of the motor control program will be described with reference to FIG. 8. FIG. 8 is a flowchart illustrating an operation of storing the communication control program.

As illustrated in FIG. 8, the user operates his or her terminal to write the user's own communication control program (communication control algorithm) in the code memory 13c of the main controller 1b through the input/output unit 12 (step S31). By using the user's own communication control program, it is possible to implement communication functions that are not provided by default configuration.

Next, the main control core 11 provides a transfer instruction to the control circuit 14. The control circuit 14 reads out and transfers, at a high speed (e.g., DMA transfer), the user's own communication control program stored in the code memory 13c, and outputs the user's own communication control program, as a transfer signal Strns2, to the RAM 33 of the communication controller 3 (step S32).

Next, the RAM 33 stores the transferred user's own communication control program (step S33).

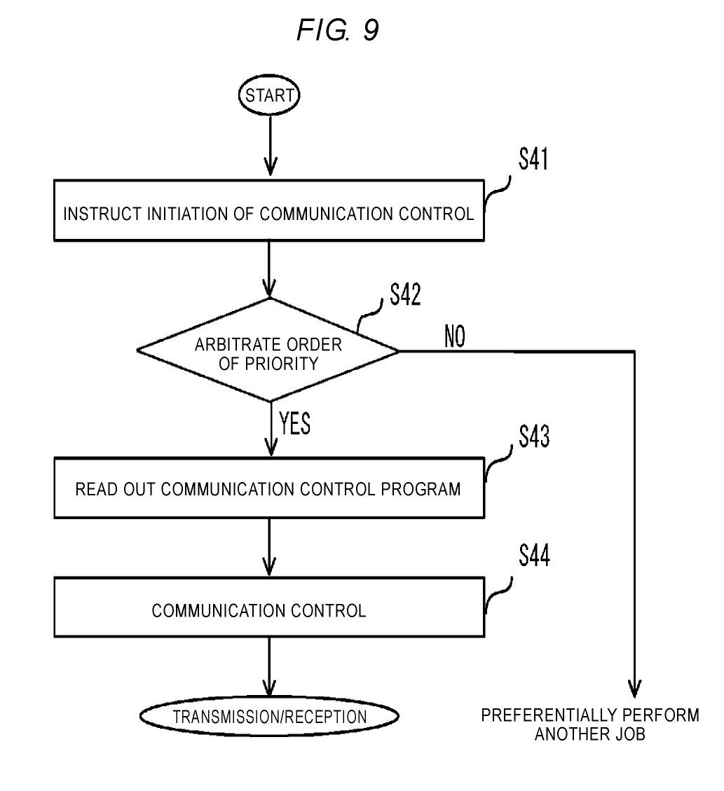

Next, an operation of the motor control system will be described with reference to FIG. 9. FIG. 9 is a flowchart illustrating an operation of the motor control system.

As illustrated in FIG. 9, the main control core 11 instructs the communication control core 31 to initiate the communication control (step S41).

Next, the arbitration circuit 4a determines the order of priority of the multiple jobs to be performed by the motor control system 100 (step S42). When the arbitration circuit 4a determines the priority of the communication control as a top priority (YES at step S42), the arbitration circuit 4a transfers the instruction of the initiation of the communication control to the communication control core 31 of the communication controller 3 on the top priority basis. When the arbitration circuit 4a does not determine the priority of the communication control as the top priority (NO at step S42), the arbitration circuit 4a determines another job (e.g., the motor control) as a top priority.

Next, the communication control core 31 reads out the user's own communication control program stored in the RAM 33 (step S43).

The communication control core 31 initiates the transmission/reception based on the user's own communication control program (step S44).

As described above, the motor control system 102 of an embodiment is provided with the main controller 1b, the motor controller 2, the communication controller 3, the arbitration circuit 4a, the motor 7, the sensor 8, the inverter 9, the AD converter 10, and the transmission/reception unit 60. The main controller 1b integrally controls the motor control system 102. The main controller 1b includes the main bus 5, the main control core 11, the input/output unit 12, the code memory 13c, the control circuit 14, the RAM 15, and the ROM 16. The user's own motor control program or communication control program is stored in the code memory 13c by the user. The communication controller 3 includes the communication control bus 50, the communication control core 31, the control circuit 32, the RAM 33, and the RAM 34. The user's own motor control program stored in the code memory 13c is transferred to the RAM 23 of the motor controller 2, and the user's own communication control program stored in the code memory 13c is transferred to the RAM 33 of the communication controller 3. The arbitration circuit 4a determines the order of priority of the multiple jobs to be performed on the main bus 5, the motor control bus 6, and the communication control bus 50.

For this reason, the motor control system 102 may implement the user's own motor driving control or communication control. In addition, the motor control program (i.e., motor control algorithm) stored in the RAM 23 cannot be read out from the main controller 1b and the outside, and the communication control program (i.e., communication control algorithm) stored in the RAM 33 cannot be read out from the main controller 1b and the outside such that it is possible to improve security.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A motor control system comprising:
a motor;
a main controller configured to receive a first user program from a user device; and
a motor controller configured to:
store the first user program transferred from the main controller such that the first user program is not readable from outside of the motor control system; and
control the motor according to the stored first user program.

2. The motor control system according to claim 1, wherein
the main controller comprises:
a first processor configured to control the motor control system; and
a first memory that stores the received first user program,
the motor controller comprises:
a second processor configured to execute the first user program to control the motor; and
a second memory that stores the transferred first user program,
an arbitration circuit that is connected to both a first bus of the main controller and a second bus of the motor controller and that is configured to arbitrate access to the first and the second bus, and
the second memory is not connected to the second bus to prevent the transferred first user program from being readable from outside of the motor control system.

3. The motor control system according to claim 2, wherein
the main controller comprises a control circuit that transfers the first user program to the second memory.

4. The motor control system according to claim 2, wherein
by executing the first user program, the second processor carries out at least one of: sensorless motor control, motor position estimation control, dead time compensation control, and motor electric current acquisition control.

5. The motor control system according to claim 2, wherein
the motor controller comprises a third memory that stores data related to motor control carried out by the second processor.

6. The motor control system according to claim 5, wherein
the third memory is not connected to the second bus to prevent the data from being readable from outside of the motor control system.

7. The motor control system according to claim 2, wherein
the second processor is configured to generate a pulse width modulation output signal for an inverter connected to the motor.

8. The motor control system according to claim 2, wherein
the second processor is configured to process information received from a sensor for the motor.

9. The motor control system according to claim 2, wherein
the second processor is configured to detect an amount of current flowing through an inductor of the motor.

10. The motor control system according to claim 2, wherein
the main controller comprises an encryption circuit configured to encrypt the first user program.

11. The motor control system according to claim 10, wherein
the first memory comprises a secure area for storing the encrypted first user program.

12. The motor control system according to claim 10, further comprising:
a decoder configured to decrypt the encrypted first user program stored in the first memory and store the decrypted first user program in the second memory.

13. The motor control system according claim 1, wherein
the main controller is configured to receive a second user program from the user device, and
the motor control system further comprises:
a communication device; and
a communication controller configured to:
store the second user program transferred from the main controller such that the second user program is not readable from outside of the motor control system; and
control the communication device according to the stored second user program.

14. The motor control system according claim 13, wherein
the main controller comprises:
a first processor configured to control the motor control system; and
a first memory that stores the first and the second user program,
the motor controller comprises:
a second processor configured to execute the first user program to control the motor; and
a second memory that stores the transferred first user program,
the communication controller comprises:
a third processor configured to execute the second user program to control the communication device; and
a third memory that stores the transferred second user program,
an arbitration circuit that is connected to a first bus of the main controller, a second bus of the motor controller, and a third bus of the communication controller and that is configured to arbitrate access to the first, the second, and the third bus, and
the second and the third memory are not connected to the second and the third bus to prevent the first and the second user program from being readable from outside of the motor control system.

15. The motor control system according to claim 14, wherein
the main controller comprises a control circuit that transfers the first and the second user program received from the user device to the second memory and the third memory, respectively.

16. The motor control system according to claim 14, wherein
the motor controller comprises a fourth memory that stores data related to motor control carried out by the second processor, and
the communication controller comprises a fifth memory that stores data related to communication control carried out by the third processor.

17. A control system comprising:
a motor;
a communication device;
a main controller configured to receive a first and a second user program from a user device;
a motor controller configured to:
store the first user program transferred from the main controller such that the first user program is not readable from outside of the control system; and
control the motor according to the stored first user program; and
a communication controller configured to:
store the second user program transferred from the main controller such that the second user program is not readable from outside of the control system; and
control the communication device according to the stored second user program.

18. The control system according to claim 17, wherein
the main controller comprises:
a first processor configured to control the control system; and
a first memory that stores the received first user program,
the motor controller comprises:
a second processor configured to execute the first user program to control the motor; and
a second memory that stores the transferred first user program,
the communication controller comprises:
a third processor configured to execute the second user program to control the communication device; and
a third memory that stores the transferred second user program,
an arbitration circuit that is connected to a first bus of the main controller, a second bus of the motor controller, and a third bus of the communication controller and that is configured to arbitrate access to the first, the second, and the third bus, and
the second and the third memory are not connected to the second and the third bus to prevent the first and the third user program from being readable from outside of the control system.

19. The control system according to claim 18, wherein
the main controller comprises a control circuit that transfers the first and the second user program received from the user device to the second memory and the third memory, respectively.

20. The control system according to claim 18, wherein
by executing the second user program, the second processor carries out at least one of: sensorless motor control, motor position estimation control, dead time compensation control, and motor electric current acquisition control.
